(19) United States
(12) Patent Application Publication
(10) Pub. No.: US 2015/0070762 A1
(43) Pub. Date: Mar. 12, 2015

(54) POLARIZER, DISPLAY DEVICE HAVING THE SAME, AND METHOD OF MANUFACTURING THE SAME

(71) Applicant: Samsung Display Co., Ltd., Yongin-City (KR)

(72) Inventors: Moonjung AN, Seoul (KR); Hyungbin CHO, Seongnam-si (KR); JUNG GUN NAM, Seoul (KR); Dae-Young LEE, Seoul (KR); GUGRAE JO, Asan-si (KR)

(73) Assignee: Samsung Display Co., Ltd., Yongin-City (KR)

(21) Appl. No.: 14/208,935

(22) Filed: Mar. 13, 2014

(30) Foreign Application Priority Data
Sep. 10, 2013 (KR) 10-2013-0108232

(51) Int. Cl. G02B 5/30; G02B 1/12

(52) U.S. Cl. CPC G02B 5/3058; G02B 1/12
USPC 359/485.05; 216/24

(57) ABSTRACT

A polarizer includes a base substrate, a metal wire layer disposed on the base substrate, and a plurality of wire grid patterns disposed on the base substrate or the metal wire layer.

This application claims priority to Korean Patent Application No. 10-2013-0108232, filed on Sep. 10, 2013, and all the benefits accruing therefrom under 35 U.S.C. §119, the content of which in its entirety is herein incorporated by reference.

### BACKGROUND

1. Field

The disclosure relates to a polarizer, a display device including the polarizer, and a method of manufacturing the polarizer. More particularly, the disclosure relates to a polarizer with improved reflection efficiency of light, a display device including the polarizer, and a method of manufacturing the polarizer.

2. Description of the Related Art

In general, metal wires arrayed to be spaced apart from each other selectively transmit or reflect polarized light of an electromagnetic wave. That is, when a pitch of arrangement of the metal wires is shorter than a wavelength of the electromagnetic wave, a polarized light component substantially in parallel to the metal wires is reflected by the metal wires and a polarized light component substantially vertical to the metal wires transmits through the metal wires.

A polarizer is manufactured with the above-mentioned phenomenon to have high polarizing efficiency and transmittance and wide viewing angle, which is called a wire grid polarizer.

In recent years, the wire grid polarizer is applied to a display device.

### SUMMARY

The disclosure provides a polarizer with improved reflection efficiency of light.

The disclosure provides a display device including the polarizer.

The disclosure provides a method of manufacturing the polarizer.

An exemplary embodiment of the invention provide a polarizer including a base substrate, a metal wire layer disposed on the base substrate, and a plurality of wire grid patterns disposed on the base substrate or the metal wire layer.

Another exemplary embodiment of the invention provide a display device including a display panel which displays an image and includes a first substrate and a second substrate disposed opposite to the first substrate and coupled to the first substrate, and a backlight unit disposed at a rear of the display panel and configured to provide light to the display panel, where the first substrate includes a base substrate, an in-cell polarizer disposed on the base substrate, and a pixel array layer disposed on the base substrate and electrically insulated from the in-cell polarizer, and the in-cell polarizer includes a metal wire layer and a plurality of wire grid patterns disposed on the base substrate or the metal wire layer.

Another exemplary embodiment of the invention provide a method of manufacturing a polarizer, including sequentially providing first and second metal layers on substantially an entire of a surface of a base substrate, providing photoresist patterns on the second metal layer, providing a co-polymer layer including first and second polymers between the photoresist patterns, heat-treating the co-polymer layer to alternately arrange the first and second polymers, removing the first polymer to form a plurality of grid patterns between the photoresist patterns, where the grid patterns include the second polymer and are spaced apart from each other by a predetermined distance, and etching the second metal layer using the photoresist patterns and the grid patterns as a mask to form wire grid patterns.

According to exemplary embodiments described herein, the metal wire layer including the silver nano-wire is disposed on the polarizer, such that the reflectance efficiency and the light utilization efficiency of the polarizer may be improved.

In such embodiments, an air gap may be provided in the polarizer, such that the total transmittance of the display device employing the polarizer may be improved.

### BRIEF DESCRIPTION OF THE DRAWINGS

The above and other features of the exemplary embodiments of the invention will become readily apparent by reference to the following detailed description when considered in conjunction with the accompanying drawings, in which:

FIG. 1 is a perspective view of an exemplary embodiment of a polarizer, according to the invention;

FIG. 2 is a partially enlarged view of a portion I in FIG. 1;

FIG. 3 is a cross-sectional view of an alternative exemplary embodiment of a polarizer, according to the invention;

FIG. 4 is a cross-sectional view of another alternative exemplary embodiment of a polarizer, according to the invention;

FIG. 5 is a cross-sectional view of an exemplary embodiment of a display device with an in-cell polarizer;

FIG. 6 is an enlarged cross-sectional view of the in-cell polarizer shown in FIG. 5;

FIG. 7 is a cross-sectional view of an exemplary embodiment of an in-cell polarizer, according to the invention;

FIG. 8 is a cross-sectional view of an alternative exemplary embodiment of an in-cell polarizer, according to the invention;

FIG. 9 is a graph showing a reflectance versus wavelength of light incident onto a metal material;

FIG. 10 is a graph showing an increase of luminance when an in-cell polarizer includes a metal wire layer;

FIG. 11 is a graph showing a luminance distribution at various angles in accordance with A1 and A2 shown in FIG. 10;

FIG. 12 is a cross-sectional view of an alternative exemplary embodiment of a display device, according to the invention;

FIG. 13 is a partially enlarged view of a portion II in FIG. 12;

FIG. 14 is a graph showing an increase of transmittance by an air gap; and

FIGS. 15A to 15G are cross-sectional views showing of an exemplary embodiment of a method of manufacturing an in-cell polarizer, according to the invention.

### DETAILED DESCRIPTION

The invention will be described more fully hereinafter with reference to the accompanying drawings, in which various embodiments are shown. The invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings.

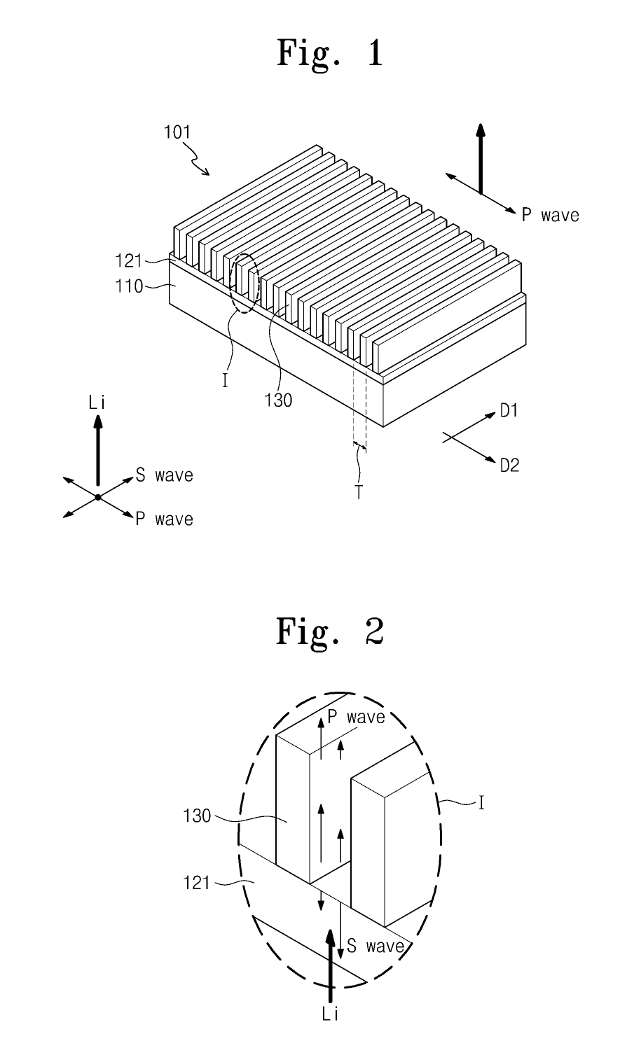

FIG. 1 is a perspective view of an exemplary embodiment of a polarizer 101, according to the invention, and FIG. 2 is a partially enlarged view of the portion I in FIG. 1.

Referring to FIGS. 1 and 2, an exemplary embodiment of the polarizer 101 includes a base substrate 110, a metal wire layer 121 disposed on the base substrate 110, and a plurality of wire grid patterns 130 disposed on the metal wire layer 121.

The base substrate 110 may include a material which transmits light, e.g., a silicon substrate. In such an embodiment, the base substrate 110 may have a rectangular shape. The metal wire layer 121 is disposed over an entire of a surface, e.g., an upper surface, of the base substrate 110. In one exemplary embodiment, for example, the metal wire layer 121 includes a silver nano-wire to diffusively reflect incident light thereto due to a Raman scattering phenomenon of the silver nano-wire.

In an exemplary embodiment, each of the wire grid patterns 130 extends substantially in a first direction D1. The first direction D1 may be substantially parallel to two opposing parallel sides among four sides of the base substrate 110. In such an embodiment, the wire grid patterns 130 are spaced apart from each other with a predetermined distance in a second direction D2, which is substantially perpendicular to the first direction D1, and the wire grid patterns 130 are substantially parallel to each other.

The polarizer 101 including the wire grid patterns 130 polarizes the incident light Li. In an exemplary embodiment, an S wave of the incident light Li, which is polarized substantially parallel to an extension direction of the wire grid patterns 130, i.e., the first direction D1, is reflected by the wire grid patterns 130, and a P wave of the incident light Li, which is polarized substantially perpendicular to the extension direction of the wire grid patterns 130, i.e., the second direction D2, transmits through the wire grid patterns 130.

In such an embodiment, where the wire grid patterns 130 has an arrangement pitch T, which is a distance between two adjacent wire grid patterns 130, the incident light Li transmits through or is reflected by the wire grid patterns 130 in accordance with the polarized direction of the S and P waves when the wavelength of the incident light Li is shorter than the arrangement pitch T of the wire grid patterns 130. The metal wire layer 121 diffusively reflects the light reflected by the wire grid patterns 130 without being incident to the wire grid patterns 130, and thus the diffusively-reflected light is re-incident to the wire grid patterns 130. A portion of the light re-incident to the wire grid patterns 130 transmits through the wire grid patterns 130 and the other portion of the light re-incident to the wire grid patterns 130 is reflected by the wire grid patterns 130. In such an embodiment, the re-incident of the light is repeated by the metal wire layer 121, and thus the reflection efficiency of the polarizer 101 may be improved.

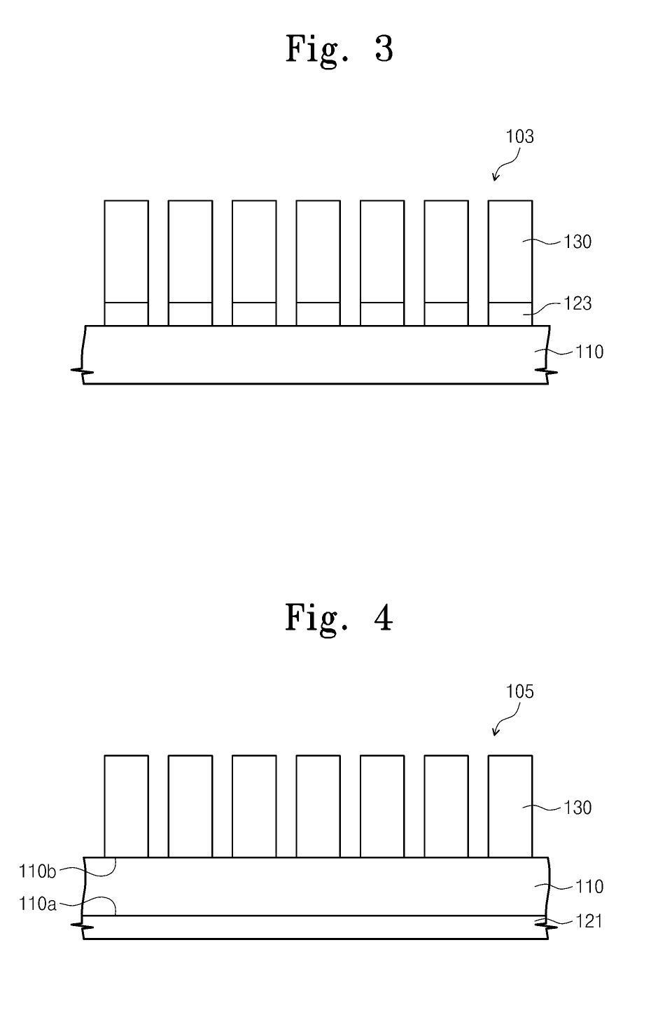

FIG. 3 is a cross-sectional view of an alternative exemplary embodiment of a polarizer 103, according to the invention.

Referring to FIG. 3, an exemplary embodiment of the polarizer 103 includes a base substrate 110, a plurality of metal wire patterns 123 disposed on the base substrate 110, and a plurality of wire grid patterns 130 disposed on the metal wire patterns 123.

In one exemplary embodiment, for example, the metal wire patterns 123 are disposed only at regions corresponding to or overlapping the wire grid patterns 130. In such an embodiment, the metal wire patterns 123 are disposed to correspond to, e.g., to overlap, the wire grid patterns 130 in a one-to-one correspondence and interposed between the base substrate 110 and the wire grid patterns 130.

The configuration and function of the polarizer 103 shown in FIG. 3 are substantially the same as the configuration and function of the polarizer 101 shown in FIGS. 1 and 2 except that the metal wire patterns 123 are disposed only at regions corresponding to or overlapping the wire grid patterns 130, and thus any repetitive detailed description thereof will be omitted.

FIG. 4 is a cross-sectional view of another alternative exemplary embodiment of a polarizer 105, according to the invention.

Referring to FIG. 4, an exemplary embodiment of the polarizer 105 includes a base substrate 110, a metal wire layer 121 disposed on a first surface 110a of the base substrate 110, and a plurality of wire grid patterns 130 disposed on a second surface 110b of the base substrate 110, which is opposite to the first surface 110a.

In such an embodiment, the first surface 110a may be a lower surface of the base substrate 110, and the second surface 110b may be an upper surface of the base substrate 110, which is opposite to the lower surface.

The configuration and function of the polarizer 105 shown in FIG. 4 are substantially the same as the configuration and function of the polarizer 101 shown in FIGS. 1 and 2 except that the metal wire layer 121 is disposed on the surface of the base substrate 110, which is different from the surface on which the wire grid patterns 130 are disposed, and thus any repetitive detailed description thereof will be omitted.

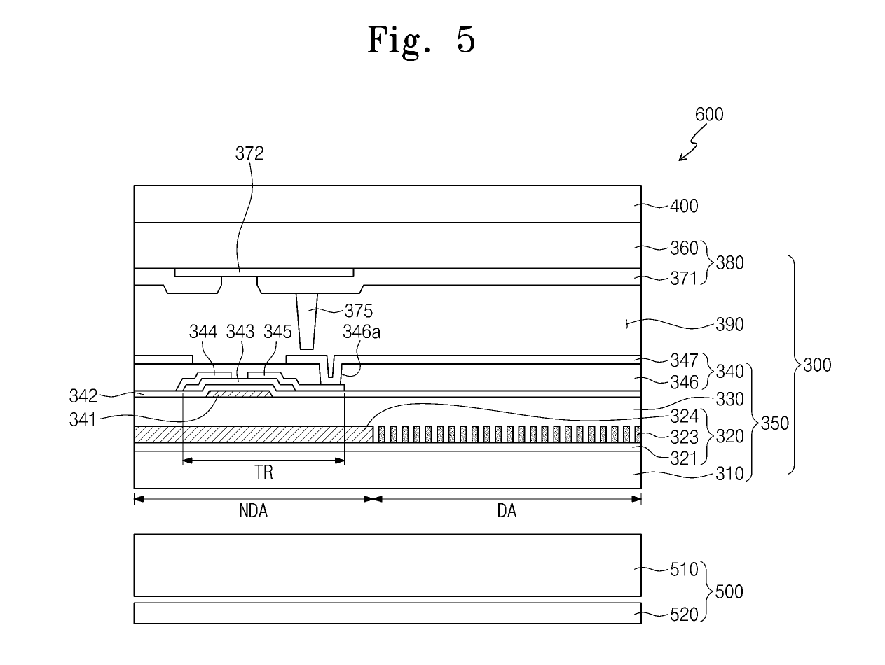

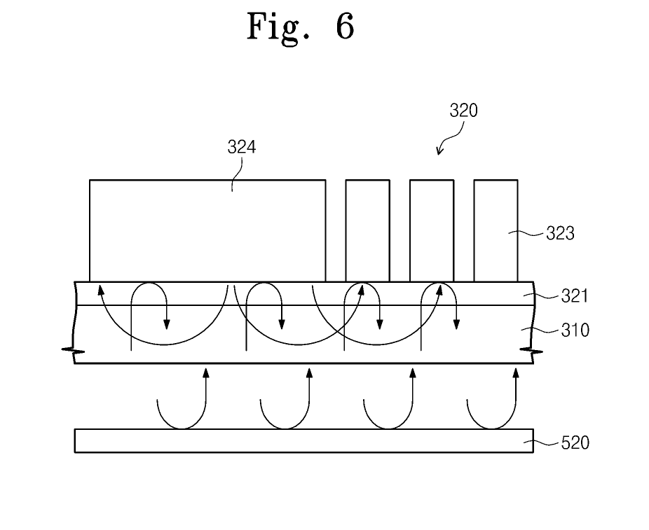

FIG. 5 is a cross-sectional view of an exemplary embodiment of a display device with an in-cell polarizer, and FIG. 6 is an enlarged cross-sectional view of the in-cell polarizer shown in FIG. 5.

Referring to FIG. 5, an exemplary embodiment of a display device 600 includes a backlight unit 500 to generate light and a display panel 300 to display an image using the light.

The backlight unit 500 includes a light source (not shown) that emits the light, a light guide plate 510 that receives the light from the light source and guides the light to the display panel 300, and a reflective plate 520 that reflects the light leaked from the light guide plate 510 to allow the reflected light to be re-incident to the light guide plate 510.

The backlight unit 500 is disposed adjacent to a rear surface of the display panel 300, and the light guide plate 510 has a size corresponding to a size of the display panel 300 and outputs the light toward the display panel 300. The reflective plate 520 has a size corresponding to a size of the lower surface of the light guide plate 510 and includes a material with high reflectance to reflect the light leaked through the lower surface of the light guide plate 510.

The display panel 300 includes a first substrate 350, a second substrate 380 facing the first substrate 350, and a liquid crystal layer 390 interposed between the first substrate 350 and the second substrate 380.

The first substrate 350 includes a first base substrate 310, an in-cell polarizer 320 disposed on the first base substrate 310, a base insulating layer 330 that covers the in-cell polarizer 320, and a pixel array layer 340 disposed on the base insulating layer 330.

The display panel 300 includes a display area DA and a non-display area NDA. The in-cell polarizer 320 includes a metal wire layer 321 disposed on the first base substrate 310. The metal wire layer 321 is disposed over substantially an entire of an inner surface of the first base substrate 310. The in-cell polarizer 320 further includes a plurality of wire grid pattern 323 disposed on the metal wire layer 321 to correspond to, e.g., to overlap, the display area DA and a first reflective pattern 324 disposed on the metal wire layer 321 to correspond to, e.g., to overlap, the non-display area NDA.

Among the light provided from the backlight unit 500, an S wave, which is polarized substantially parallel to the extension direction of the wire grid patterns 323, is reflected by the metallic properties, e.g., aluminum, of the wire grid patterns 323, and a P wave, which is polarized substantially perpendicular to the extension direction of the wire grid patterns 323, transmits through the wire grid patterns.

The first reflective pattern 324 includes a material with high reflectance, e.g., aluminum, to reflect the light provided from the backlight unit 500.

Referring to FIG. 6, in an exemplary embodiment, the light reflected by the first reflective pattern 324 is reflected by the reflective plate 520 of the backlight unit 500 and then is re-incident to the display panel 300. Accordingly, light utilization efficiency may be improved by the first reflective pattern 324 of the in-cell polarizer 320.

In such an embodiment, the light reflected by the first reflective pattern 324 is diffusively reflected by the metal wire layer 321 and then is re-incident to the wire grid pattern 323. A portion of the light re-incident to the wire grid patterns 323 transmits through the wire grid patterns 323, and the other portion of the light re-incident to the wire grid patterns 323 is reflected by the wire grid patterns 323. The re-incident of the light is repeated by the metal wire layer 321, and thus the reflection efficiency of the in-cell polarizer 320 may be improved.

Referring back to FIG. 5, the first reflective pattern 324 has a size corresponding to the non-display area NDA and reflects the light incident to the non-display area NDA to reuse the light. In such an embodiment, an amount of the light re-incident to the display area DA is increased by the first reflective pattern 324. Therefore, in an exemplary embodiment, the light utilization efficiency of the in-cell polarizer 320 may be improved by the first reflective pattern 324.

The base insulating layer 330 is disposed on the upper surface of the in-cell polarizer 320. The base insulating layer 330 covers the first reflective pattern 324 and the wire grid patterns 323. In such an embodiment, a space between the wire grid patterns 323, which are spaced apart from each other, may be filled with the base insulating layer 330. If the pixel array layer 340 is provided directly on the in-cell polarizer 320, process defects may occur due to the space between the wire grid patterns 323. Thus, in such an embodiment, the base insulating layer 330 is disposed between the pixel array layer 340 and the in-cell polarizer 320.

In an exemplary embodiment, the base insulating layer 330 includes an insulating material to electrically insulate the first reflective pattern 324 and the wire grid patterns 323 from the pixel array layer 340.

The pixel array layer 340 includes a thin film transistor TR, an inter-insulating layer 346 and a pixel electrode 347. The thin film transistor TR includes a gate electrode 341, a source electrode 344 and a drain electrode 345. In an exemplary embodiment, the gate electrode 341 is disposed on the base insulating layer 330 and covered by a gate insulating layer 342. A semiconductor layer 343 is disposed on the gate insulating layer 342 to correspond to, e.g., to overlap, the gate electrode 341, and the source electrode 344 and the drain electrode 345 are disposed on the semiconductor layer 343 to be spaced apart from each other.

The inter-insulating layer 346 is disposed on the gate insulating layer 342 to cover the thin film transistor TR, and the pixel electrode 347 is disposed on the inter-insulating layer 346. In such an embodiment, a contact hole 346a is defined through the inter-insulating layer 346 to expose the drain electrode 345 of the thin film transistor TR, and the pixel electrode 347 is electrically connected to the drain electrode 345 through the contact hole 346a.

The structure of the first substrate 350 in an exemplary embodiment of the invention is not limited to the above-mentioned structure.

The second substrate 380 includes a second base substrate 360, a color filter layer 371 and a black matrix 372. The second base substrate 360 is disposed to face the first base substrate 310, and the black matrix 372 is disposed on the second base substrate 360 to correspond to, e.g., to overlap, the non-display area NDA. The color filter layer 371 includes red, green and blue color pixels, and each of the red, green and blue color pixels is disposed to correspond to, e.g., to overlap, at least the display area DA and partially overlaps the black matrix 372.

The liquid crystal layer 390 is disposed between the first substrate 350 and the second substrate 380. The display panel 300 may further include a spacer 375 disposed between the first substrate 350 and the second substrate 380 to maintain a distance between the first and second substrates 350 and 380, and thus the liquid crystal layer 390 provided between the first and second substrates 350 and 380 may be effectively prevented from an external pressure.

In an exemplary embodiment, a dichroic polarizer 400 is disposed on the display panel 300. The dichroic polarizer 400 may have a sheet shape and may be attached to the display panel 300. The dichroic polarizer 400 has a polarizing axis substantially parallel to or vertical to the extending direction of the wire grid patterns 323 of the in-cell polarizer 320.

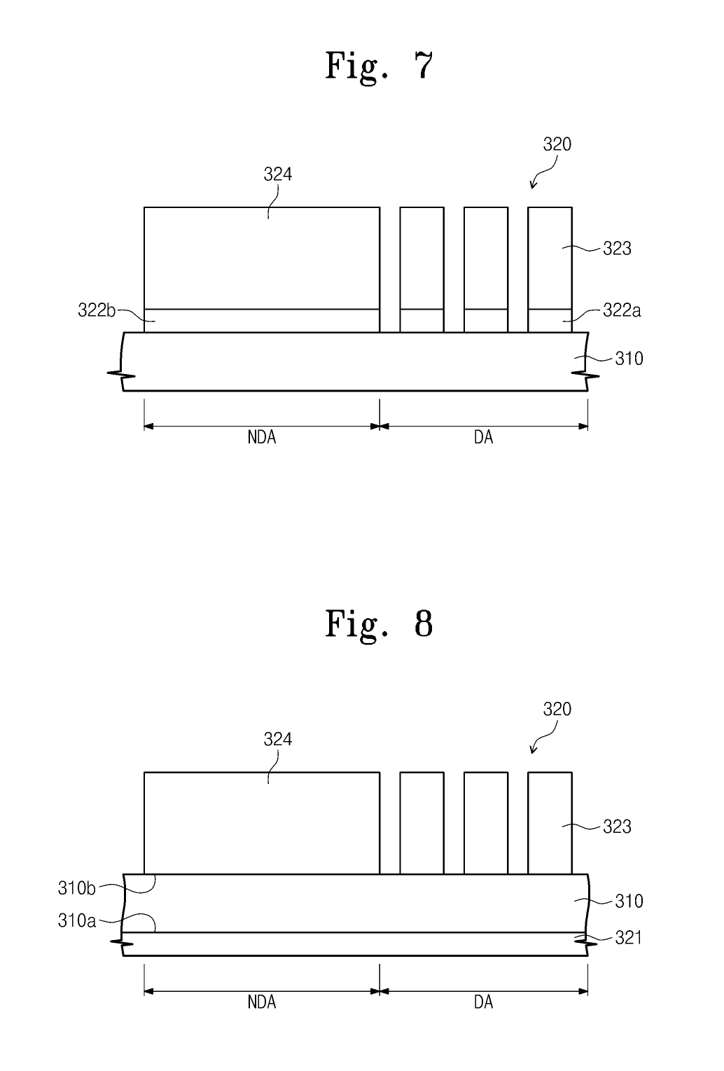

FIG. 7 is a cross-sectional view of an alternative exemplary embodiment of an in-cell polarizer 320, according to the invention.

Referring to FIG. 7, an exemplary embodiment of the in-cell polarizer 320 includes a plurality of metal wire patterns 322a disposed on a first base substrate 310 to correspond to, e.g., to overlap, the display area DA and a second reflective pattern 322b disposed on the first base substrate 310 to correspond to, e.g., to overlap, the non-display area NDA.

In such an embodiment, the in-cell polarizer 320 includes a plurality of wire grid patterns 323 disposed on the metal wire patterns 322a to correspond to, e.g., to overlap, the display area DA and a first reflective pattern 324 disposed on the second reflective pattern 322b to correspond to, e.g., to overlap, the non-display area NDA.

The metal wire patterns 322a are disposed only at regions corresponding to or overlapping the wire grid patterns 323, and the second reflective pattern 322b is disposed only at a region corresponding to or overlapping the first reflective pattern 324. In such an embodiment, the metal wire patterns 322a are disposed to correspond to, e.g., to overlap, the wire grid patterns 323 in a one-to-one correspondence and interposed between the first base substrate 310 and the wire grid patterns 323.

The configuration and function of the in-cell polarizer 320 shown in FIG. 7 are substantially the same as the configuration and function of the in-cell polarizer 320 shown in FIGS. 5 and 6 except that the metal wire patterns 322a are disposed only at the regions corresponding to the wire grid patterns 130, and thus any repetitive detailed description thereof will be omitted.

FIG. 8 is a cross-sectional view showing another alternative exemplary embodiment of an in-cell polarizer 320, according to the invention.

Referring to FIG. 8, an exemplary embodiment of the in-cell polarizer 320 includes a metal wire layer 321 disposed on a first surface 310a of a first base substrate 310, a plurality of wire grid patterns 323 disposed on a second surface 310b of the first base substrate 310 to correspond to, e.g., to overlap, the display area DA, and a first reflective pattern 324 disposed on the second surface 310b of the first base substrate 310 to correspond to, e.g., to overlap, the non-display area NDA.

In such an embodiment, the first surface 310a may be a lower surface of the first base substrate 310, and the second surface 310b may be an upper surface of the first base substrate 310, which is opposite to the lower surface.

The configuration and function of the in-cell polarizer 320 shown in FIG. 8 are substantially the same as the configuration and function of the in-cell polarizer 320 shown in FIGS. 5 and 6 except that the metal wire layer 321 is disposed on the surface of the first base substrate 310, which is different from the surface on which the wire grid patterns 323 and the first reflective pattern 324 are disposed, and thus any repetitive detailed description thereof will be omitted.

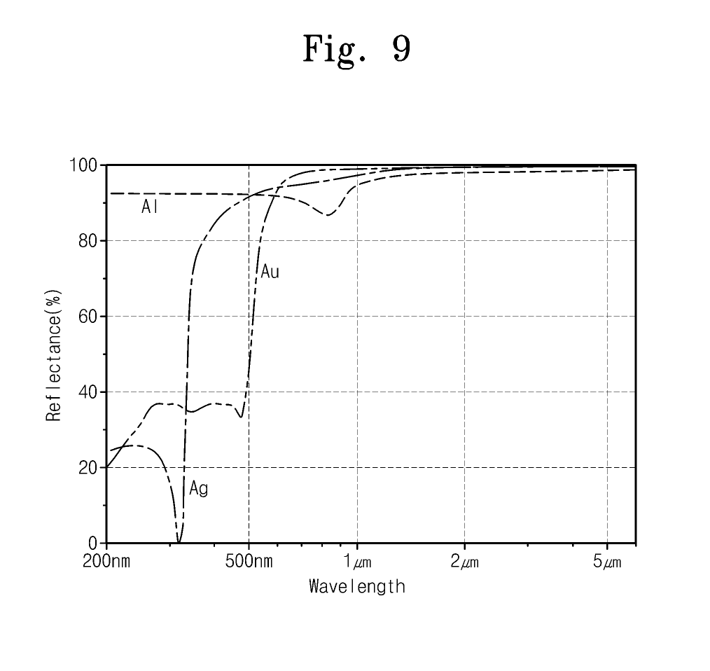

FIG. 9 is a graph showing reflectance versus wavelength of light incident onto a metal material.

Referring to FIG. 9, the reflectance of a metal material is changed in accordance with the wavelength. For instance, aluminum (Al) has the reflectance of about 90% in the wavelength range of about 200 nanometers (nm) to about 5 micrometers (μm). Meanwhile, silver (Ag) has the reflectance lower than the reflectance of aluminum (Al) in the wavelength range of about 200 nm to about 500 nm, but has the reflectance higher than the reflectance of aluminum (Al) in the wavelength range of about 500 nm to about 5 μm.

Accordingly, when the in-cell polarizer 320 includes the wire grid patterns 323 of aluminum (Al) and the metal wire layer 321 of silver (Ag), the total reflectance of the in-cell polarizer 320 is higher more than the reflectance of the in-cell polarizer including only a single metal material.

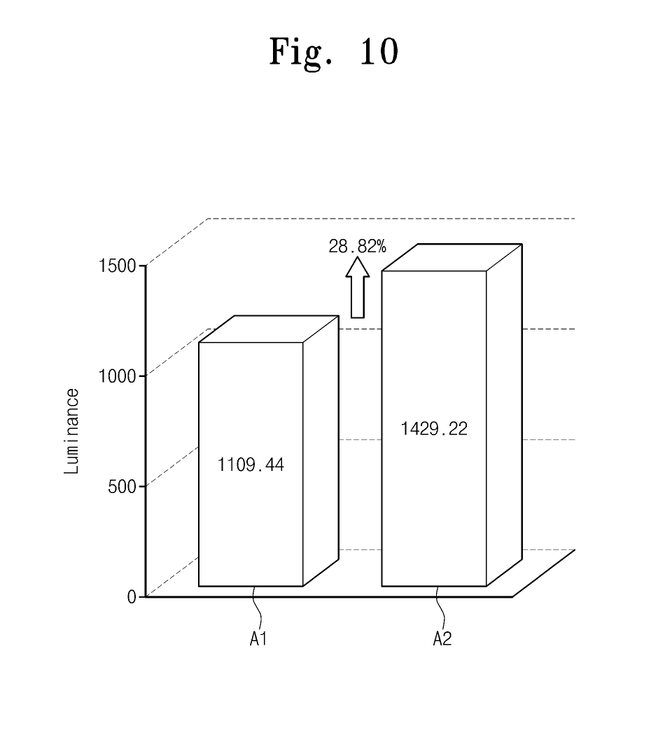

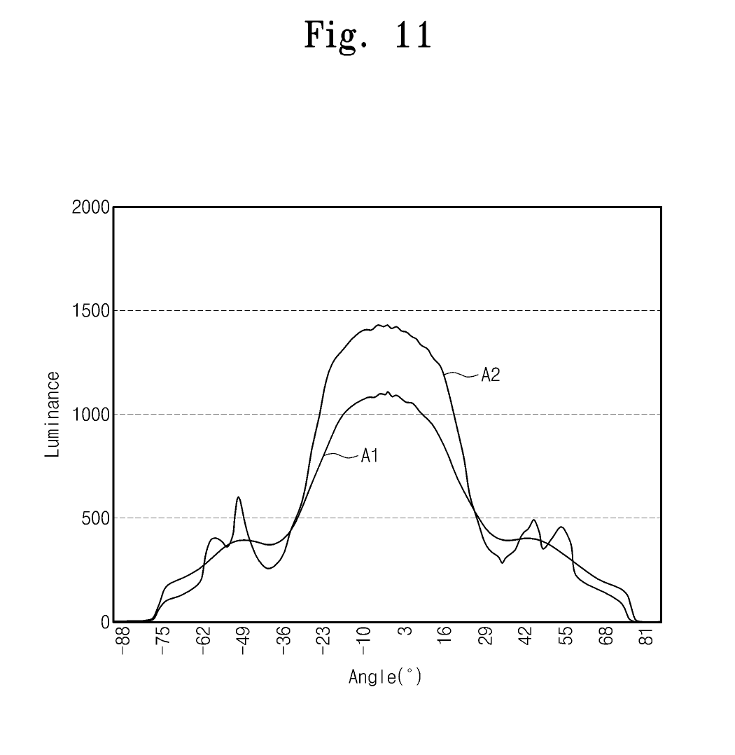

FIG. 10 is a graph showing an increase of luminance when an in-cell polarizer includes a metal wire layer, and FIG. 11 is a graph showing a luminance distribution at various angles in accordance with A1 and A2 shown in FIG. 10.

In FIGS. 10 and 11, “A1” indicates a first case in which the backlight unit includes a diffusion plate and the metal wire layer is omitted from the in-cell polarizer, and “A2” indicates a second case in which the diffusion plate is omitted from the backlight unit and the metal wire layer 321, e.g., silver nano-wire, is included to the in-cell polarizer 320.

Referring to FIGS. 10 and 11, the total luminance of the second case A2 is higher than the total luminance of the first case A1. As shown in FIG. 10, the total luminance of the first case A1 is represented at about 1109.44 and the total luminance of the second case A2 is represented at about 1429.22, that is, the total luminance of the second case A2 is higher than that of the first case A1 by about 28.8%. As shown in FIG. 11, the luminance of the first case A1 at a side portion of the display device is similar to the luminance of the second case A2 at the side portion of the display device, but the luminance of the second case A2 at a front portion of the display device is higher than the luminance of the first case A1 at the front portion of the display device.

Accordingly, the total luminance and the front luminance of the display device 600 are higher in the second case A2 than the total luminance and the front luminance of the display device 600 in the first case A1.

As described above, in an exemplary embodiment, where the in-cell polarizer 320 includes the metal wire layer 321, the luminance of the display device 600 becomes high even though the backlight unit 500 does not include the diffusion plate (or diffusion sheet).

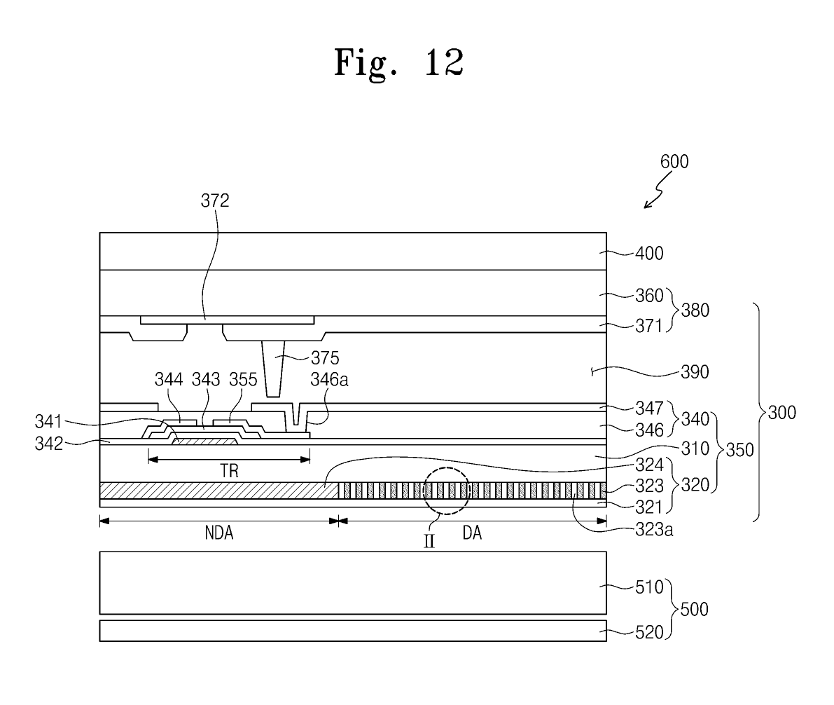

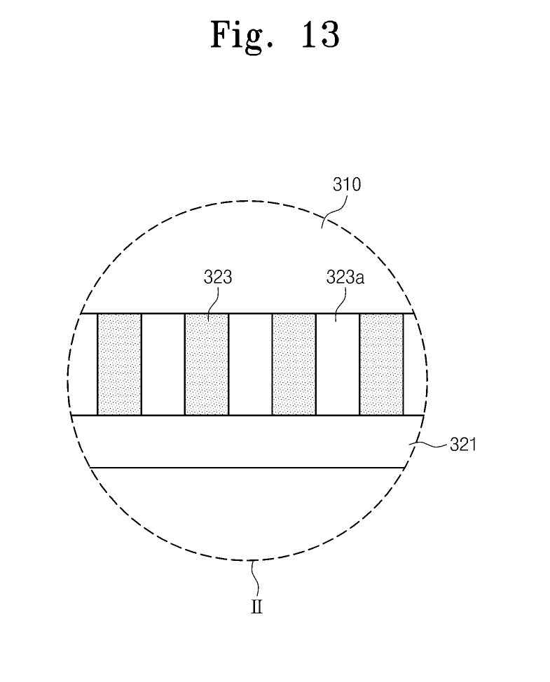

FIG. 12 is a cross-sectional view of an alternative exemplary embodiment of a display device, according to the invention, and FIG. 13 is a partially enlarged view of portion II shown in FIG. 12.

The display device in FIG. 12 is substantially the same as the display device shown in FIG. 5 except for the in-cell polarizer 320. The same or like elements shown in FIG. 12 have been labeled with the same reference characters as used above to describe the exemplary embodiments of the display device shown in FIG. 5 and any repetitive detailed description thereof will hereinafter be omitted or simplified.

Referring to FIGS. 12 and 13, in an alternative exemplary embodiment of display device, the first substrate 350 includes the first base substrate 310, the in-cell polarizer 320 disposed on the first surface 310a (shown in FIG. 8) of the first base substrate 310, and the pixel array layer 340 disposed on the second surface 310b (shown in FIG. 8) of the first base substrate 310.

The display panel 300 includes the display area DA and the non-display area NDA. The in-cell polarizer 320 further includes the wire grid patterns 323 disposed on the first base substrate 310 to correspond to, e.g., to overlap, the display area DA and the first reflective pattern 324 disposed on the first base substrate 310 to correspond to, e.g., to overlap, the non-display area NDA. The in-cell polarizer 320 includes the metal wire layer 321 to cover the wire grid patterns 323 and the reflective pattern 324.

In one exemplary embodiment, for example, the metal wire layer 321 may include the silver nano-wire. In such an embodiment, a space between the wire grid patterns 323 spaced apart from each other is not filled with the metal wire layer 321. Accordingly, the in-cell polarizer 320 may include an air gap 323a defined by the first base substrate 310, the metal wire layer 321 and adjacent wire grid patterns 323.

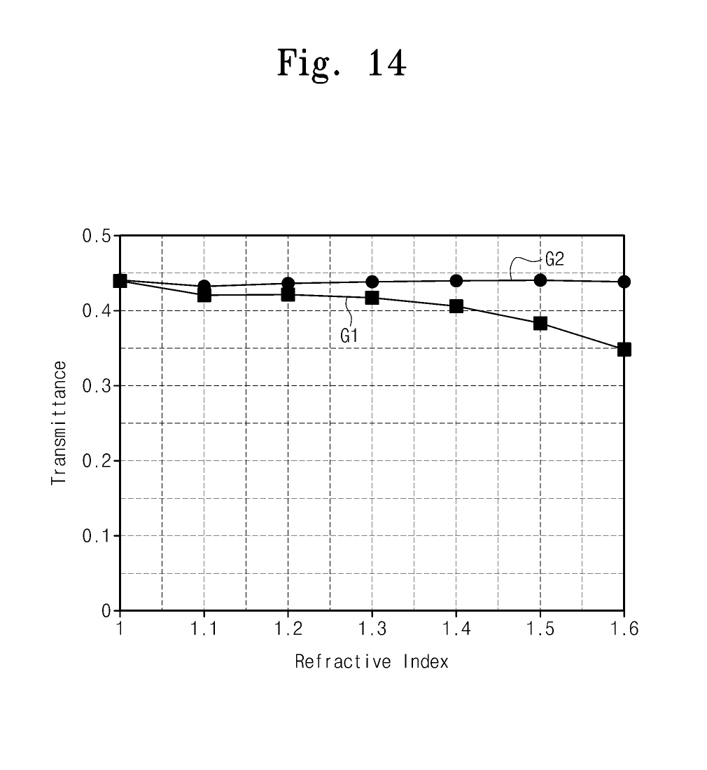

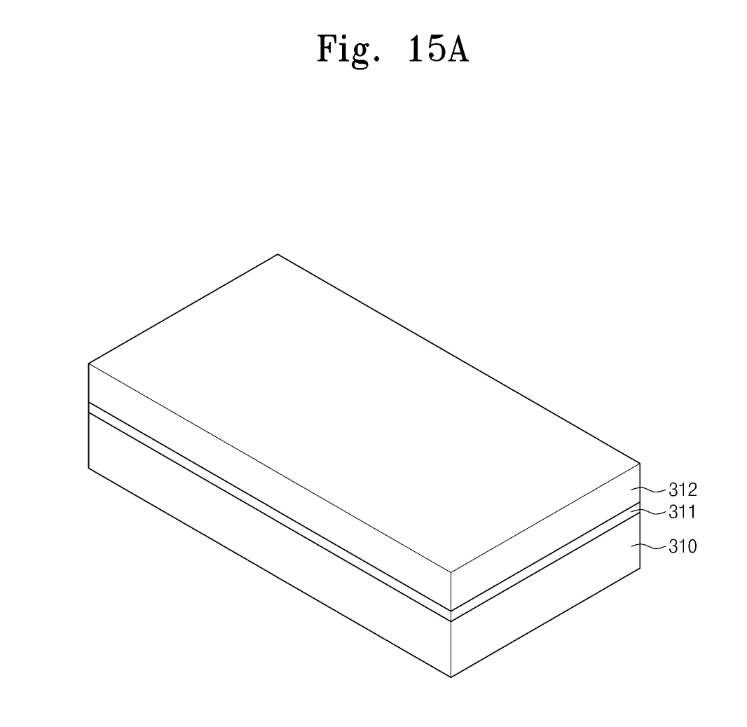

FIG. 14 is a graph showing an increase of transmittance due to the air gap. In FIG. 14, a first graph G1 represents the transmittance when the air gap 323a does not exist in the in-cell polarizer 320, and a second graph G2 represents the transmittance when the air gap 323a exists in the in-cell polarizer 320. In FIG. 14, an x-axis represents a refractive index of a material filled in the space between the wire grid patterns, e.g., a material of the base insulating layer 330, when the air gap does not exist.

When the space between the wire grid patterns 323 of the in-cell polarizer 320 is filled with the base insulating layer 330 (shown in FIG. 5), the transmittance is higher when the air gap 323a exists than that when the air gap 323a does not exists regardless of the refractive index of the base insulating layer 330. As shown in FIG. 14, in such an embodiment, where the air gap 323a is defined in the in-cell polarizer 320, the total transmittance of the display device 600 may be improved.

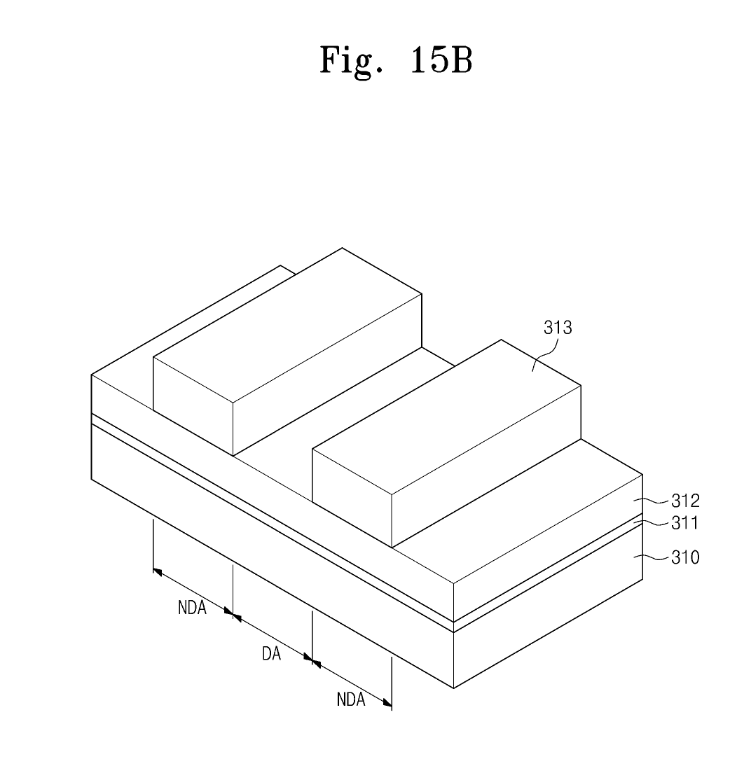

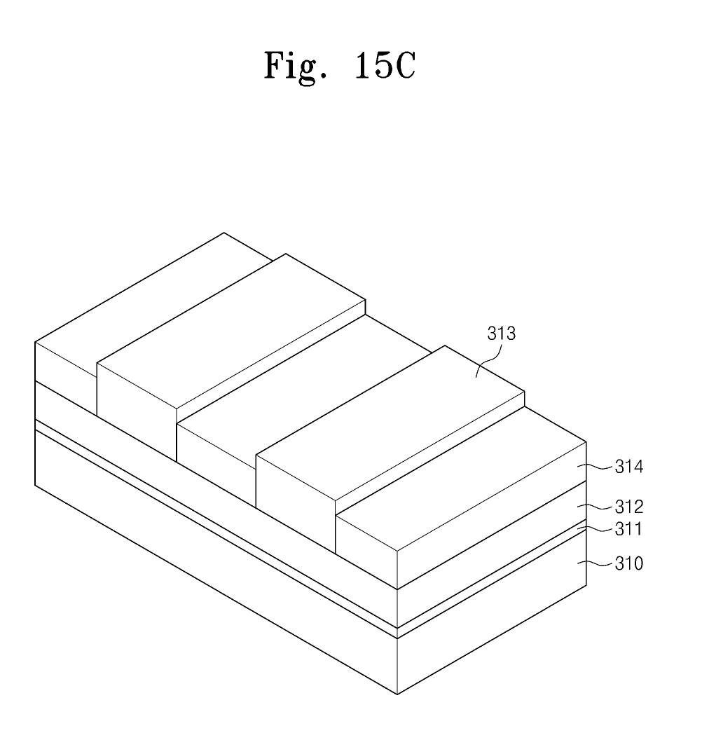

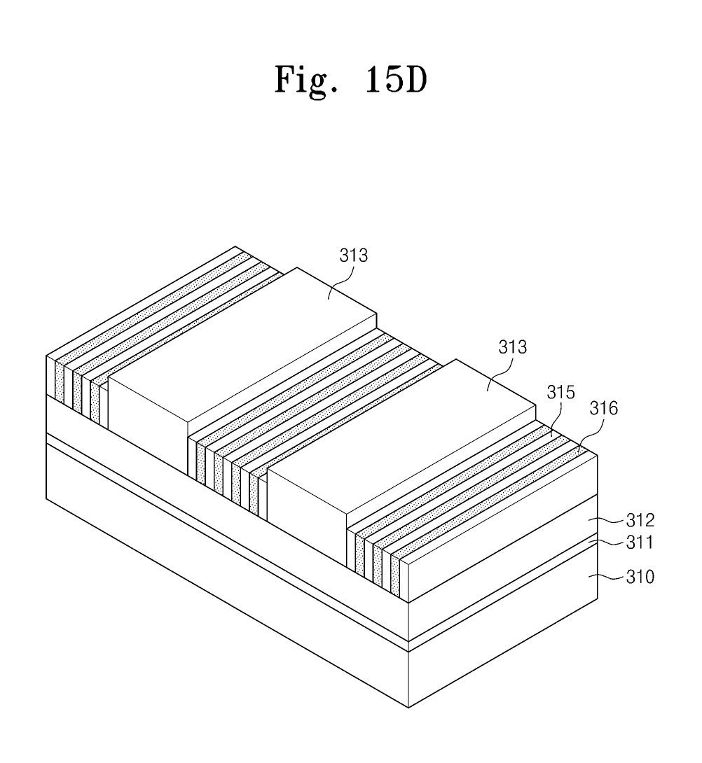

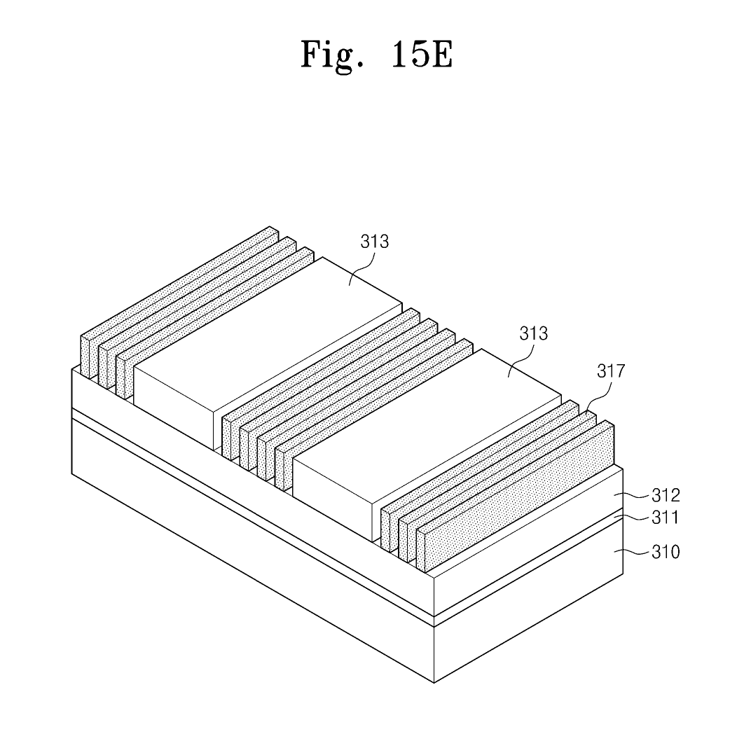

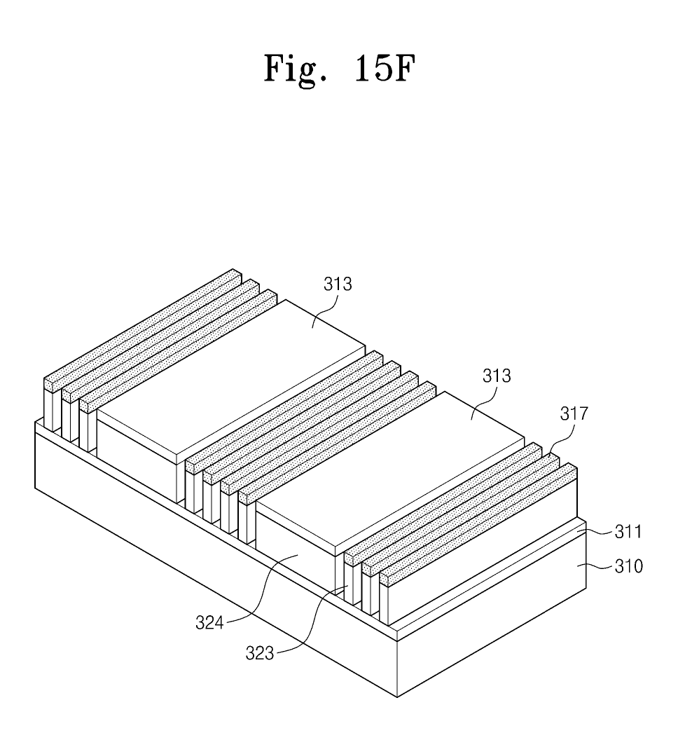

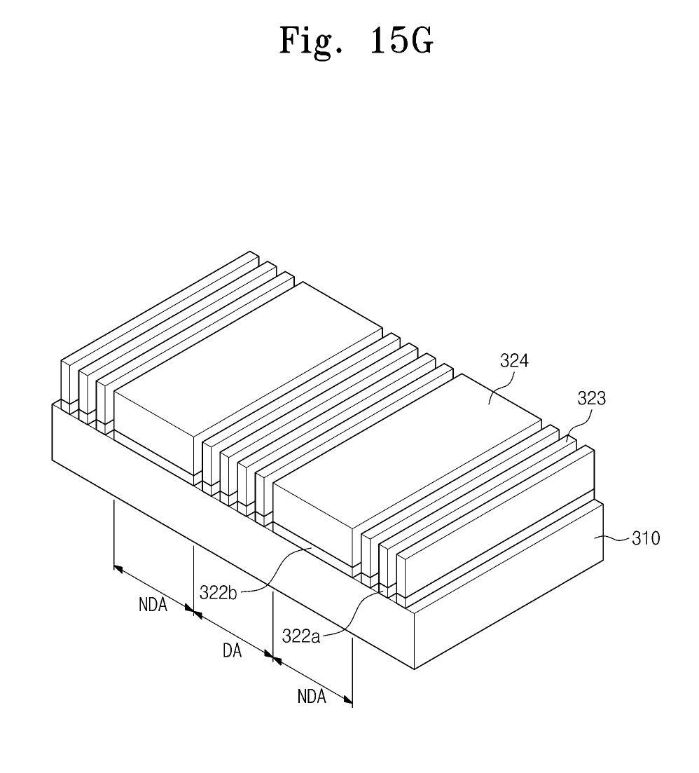

FIGS. 15A to 15G are cross-sectional views showing an exemplary embodiment of a method of manufacturing an in-cell polarizer, according to the invention.

Referring to FIG. 15A, a first metal layer 311 and a second metal layer 312 are sequentially provide, e.g., formed, on a first base substrate 310. The first and second metal layers 311 and 312 include different metal materials from each other. In one exemplary embodiment, for example, the first metal layer 311 includes silver nano-wire, and the second metal layer 312 includes aluminum (Al).

As shown in FIG. 15B, photoresist patterns 313 are provided on the second metal layer 312. The photoresist patterns 313 are disposed to correspond to, e.g., to overlap, the non-display area NDA and not disposed in the display area DA.

Referring to FIG. 15C, a space between the photoresist patterns 313 is filled with a co-polymer layer 314. In an exemplary embodiment, the co-polymer layer 314 is formed to have a height less a height of each photoresist pattern 313. In one exemplary embodiment, for example, the co-polymer layer 314 includes a first polymer and a second polymer, which are disorderedly aligned in various directions. In such an embodiment, the first polymer may be, but not limited to, polymethylmethacrylate (“PMMA”) and the second polymer may be, but not limited to, polystyrene (“PS”).

Then, the co-polymer layer 314 may be heat-treated. When the co-polymer layer 314 is heat-treated, the co-polymer layer 314 is phase separated into first and second polymers 315 and 316 as shown in FIG. 15D. In an exemplary embodiment, the first and second polymers 315 and 316 may be alternately arranged with each other between the photoresist patterns 313 by the heat-treatment.

Then, one of the first and second polymers 315 and 316 is removed, and the other one of the first and second polymers 315 and 316 remains between the photoresist patterns 313 to form a nano-grid pattern 317 as shown in FIG. 15E. In an exemplary embodiment, the first polymer 315 including PMMA is removed, and the second polymer 316 remains to form the nano-grid pattern 317.

Then, the second metal layer 312 is etched using the nano-grid pattern 317 and the photoresist patterns 313 as a mask, such that the wire grid patterns 323 and the first reflective pattern 324 are provided on the first metal layer 311 as shown in FIG. 15F.

In such an embodiment, the first metal layer 311 may be etched using the wire grid patterns 323 and the first reflective pattern 324 as a mask, such that the metal wire patterns 322a corresponding to the wire grid patterns 323 and the second reflective pattern 322b corresponding to the first reflective pattern 324 may be provided on the first base substrate 310 as shown in FIG. 15G. In such an embodiment, the metal wire patterns 322a are disposed at an area corresponding to the display area DA and the second reflective pattern 322b is disposed at an area corresponding to the non-display area NDA.

Although some exemplary embodiments of the invention have been described herein, it is understood that the invention should not be limited to these exemplary embodiments but various changes and modifications can be made by one ordinary skilled in the art within the spirit and scope of the invention as hereinafter claimed.

What is claimed is:

1. A polarizer comprising:
a base substrate;
a metal wire layer disposed on the base substrate; and
a plurality of wire grid patterns disposed on the base substrate or the metal wire layer.

2. The polarizer of claim 1, wherein
the metal wire layer comprises a metal nano-wire, and
the wire grid patterns comprise a metal material having a reflectance different from a reflectance of the metal nano-wire in each wavelength.

3. The polarizer of claim 2, wherein
the metal nano-wire comprises a silver nano-wire, and
the metal material comprises aluminum.

4. The polarizer of claim 1, wherein
the metal wire layer is disposed between the base substrate and the wire grid patterns, and
the metal wire layer comprises metal wire patterns disposed to correspond to the wire grid patterns in a one-to-one correspondence.

5. The polarizer of claim 1, wherein
the metal wire layer is disposed on a first surface of the base substrate, and
the wire grid patterns are disposed on a second surface of the base substrate.

6. A display device comprising:
a display panel which displays an image, wherein the display panel comprises:
a first substrate; and
a second substrate disposed opposite to the first substrate and coupled to the first substrate; and
a backlight unit disposed at a rear of the display panel and configured to provide light to the display panel,
wherein the first substrate comprises:
a base substrate;
an in-cell polarizer disposed on the base substrate; and
a pixel array layer disposed on the base substrate and electrically insulated from the in-cell polarizer, wherein the in-cell polarizer comprises:
a metal wire layer; and
a plurality of wire grid patterns disposed on the base substrate or the metal wire layer.

7. The display device of claim 6, wherein
the metal wire layer comprises a first metal material, and
the wire grid patterns comprise a second metal material having a reflectance different from a reflectance of the first metal material in each wavelength.

8. The display device of claim 7, wherein
the first metal material comprises silver (Ag), and
the second metal material comprises aluminum.

9. The display device of claim 6, wherein
the metal wire layer is disposed between the base substrate and the wire grid patterns, and
the metal wire layer is disposed to cover a substantially entire of a surface of the base substrate.

10. The display device of claim 6, wherein
the metal wire layer is disposed between the base substrate and the wire grid pattern, and
the metal wire layer comprises metal wire patterns disposed to correspond to the wire grid patterns in a one-to-one correspondence.

11. The display device of claim 6, wherein
the metal wire layer is disposed on a first surface of the base substrate, and
the wire grid patterns are disposed on a second surface of the base substrate.

12. The display device of claim 9, wherein the first substrate further comprises a base insulating layer disposed between the pixel array layer and the wire grid patterns.

13. The display device of claim 6, wherein
the in-cell polarizer is disposed on a first surface of the base substrate, and
the pixel array layer is disposed on a second surface of the base substrate.

14. The display device of claim 13, wherein
the wire grid patterns are disposed on the first surface of the base substrate, and
the metal wire layer is disposed on the wire grid patterns.

15. The display device of claim 14, wherein
an air gap is defined in the in-cell polarizer between the wire grid patterns, by the base substrate, and the metal wire layer spaced apart from the base substrate.

16. The display device of claim 6, wherein
the display panel comprises a display area and a non-display area,
the wire grid patterns are disposed to correspond to the display area, and
the in-cell polarizer comprises a first reflective pattern disposed to correspond to the non-display area.

17. The display device of claim 16, wherein
the metal wire layer comprises metal wire patterns disposed to correspond to the wire grid patterns in a one-to-one correspondence in the display area and a second reflective pattern disposed to correspond to the first reflective pattern in the non-display area.

18. A method of manufacturing a polarizer, the method comprising:
sequentially providing first and second metal layers on substantially an entire of a surface of a base substrate;
providing photoresist patterns on the second metal layer;
providing a co-polymer layer comprising first and second polymers on the second metal layer between the photoresist patterns;
heat-treating the co-polymer layer to alternately arrange the first and second polymers;
removing the first polymer in the co-polymer layer to form a plurality of grid patterns between the photoresist patterns, wherein the grid patterns comprise the second polymer and are spaced apart from each other by a predetermined distance; and
etching the second metal layer using the photoresist patterns and the grid patterns as a mask to form wire grid patterns.

19. The method of claim 18, further comprising:
etching the first metal layer using the wire grid patterns as a mask to form metal wire patterns corresponding to the wire grid patterns in a one-to-one correspondence.

20. The method of claim 18, wherein
the first metal layer comprises silver nano-wire, and
the second metal layer comprises aluminum.
